(19) United States
(12) Patent Application Publication
(10) Pub. No.: US 2002/0113004 A1
(43) Pub. Date: Aug. 22, 2002

(54) Clam shell UF centrifugal filter vessel and method

(76) Inventors: William F. Bowers, Topsfield, MA (US); Timothy Towle, Lee, NH (US)

Correspondence Address: NUTTER MCCLENNEN & FISH LLP, ONE INTERNATIONAL PLACE, BOSTON, MA, 02110, US

(21) Appl. No.: 09/966,732

(22) Filed: Sep. 28, 2001

Related U.S. Application Data
(60) Provisional application No. 60/236,078, filed on Sep. 28, 2000.

(51) Int. Cl. B01D 63/00

(52) U.S. Cl. 210/321.6

(57) ABSTRACT

A clamshell fabrication process wherein an ultrafiltration (UF) vessel (or a strip or array of filter vessels) is formed using half cells joined along a central plane to form each vessel. A filter membrane covers a port of the cell, and an outer body is overmolded to form the completed vessel. Two filter membranes are crushed together skin to skin. When applied to strips of half cells, a multi-well strip or array is formed, with sample-holding reservoirs formed by the space created between two strips of half-cells for each row of filter cells. The membrane thus covers the entire wetted interior of each cell, and may extend from near the opening at the top of an open cell to a conical bottom of the cell. A number of strip assemblies can be formed together to create larger arrays of filter cells. The overmolding process creates a crush seal with edges of the filter membrane. The vessel may have a regenerated surface, or be surface treated to be non-retentive, further enhancing yield when used to process sticky or adherent materials, such as proteins and biomolecules. This provides quantitative yields of filtrate, and retentate.

### REFERENCE TO RELATED APPLICATION

This application is related to, and claims the benefit under 35 USC 119(e) of, U.S. Provisional Application Serial No. 60/236,078, filed by applicants on Sep. 28, 2000 and entitled Clam Shell UF Centrifugal Filter. That patent application is hereby incorporated herein by reference in its entirety.

### FIELD OF THE INVENTION

The present invention relates to filter vessels for centrifugal ultrafiltration.

### BACKGROUND

It is well known to separate components of a fluid by centrifuging. Portions of different density separate in a column along the centrifugal gradient. A related development employs the centrifugal pressure to more effectively drive components of a fluid through a filter bed or sheet. Typically, this is done with special vessels or filter plate assemblies, that are constructed to fit a standard centrifuge drum, and often to hold a standard aliquot of the sample that is to be filtered. Ultrafiltration involves the separation of colloidal or large molecule material. A filter, such as a microporous membrane, allows solute and smaller molecular weight materials to pass from the vessel, while retaining the larger molecules of interest.

Centrifugal ultrafiltration relies on the pressure of a fluid head to drive the solvent and solutes through the filter, and thus may operate at a rate that varies over time as concentration proceeds. While certain microporous membranes may have a very high total effective filtration area, the pore sizes may be quite small, e.g., ten to five hundred nanometers, so that quite high driving force may be necessary as the separation proceeds. Moreover, in many fields of interest, such as separation or purification of proteins and biological molecules, the material of interest may be present in a concentration well under one percent, and may reside in a sample amounting to a few milliliters or less. In these circumstances, a number of factors of vessel and filter materials and construction may have relatively large adverse effects on the speed, efficiency and cost of ultrafiltration.

Various prior art patents have proposed constructions and methods for filter vessels and centrifugal separation. These patents include ones directed to multiwell filter plates, such as U.S. Pat. Nos. 5,674,395 (Stankowski) and 4,948,442 and 5,047,215 (Manns). Others, directed to UF Concentrators include U.S. Pat. Nos. 3,488,768 (Rigopulos); 4,755,301 and 4,632,761 (Bowers); 4,769,145 (Nakajima); 4,722,792 (Miyagi); and 5,647,990 (Vassarotti). These have all attempted to address factors related to the construction of effective centrifugal separation or UF vessels. However, the speed of concentration, the efficiency of separation and the overall yield all remain subject to rather restrictive limits, and may pose cumbersome, costly or simply formidable obstacles for many desirable UF tasks.

Thus, there remains a need for improved UF vessels and methods of making such vessels There also remains a need for improved methods of ultrafiltration separation or concentration.

### SUMMARY OF THE INVENTION

One or more of these and other desirable ends are achieved in accordance with a first aspect of the present invention by a vessel “clamshell” fabrication process wherein a filter vessel (or a strip or array of filter vessels) is formed using half cells joined along a central plane to form a cell or vessel. A filter membrane covers a port of the cell, forming a filter vessel in which the finished product has two layers of membrane crushed together skin to skin. When applied to strips of half cells, a multi-well strip or array is formed, with sample-holding reservoirs formed by the space created between two strips of half-cells for each row of filter cells. The membrane covers the entire wetted interior of each cell, and may extend from near the opening at the top of an open cell to a conical bottom of the cell. A number of strip assemblies can be formed together to create larger arrays of filter cells.

The half cells, with the filter membrane positioned therebetween, are urged together with high pressure to establish a crush seal with edges of the filter membrane and form the filter vessel(s). One or more enclosing bands are also overmolded about the vessel, providing greater radial burst strength and assuring that the completed cells do not leak. The vessel, or the clamshell material of the vessel, may have a regenerated surface, or be surface treated to be non-retentive, further enhancing yield when used to process sticky or adherent materials, such as proteins and biomolecules. This provides qualitative yields of such materials in the filtrate.

### BRIEF DESCRIPTION OF THE DRAWINGS

These and other features of the invention will be understood from the description and claims herein, taken together with figures showing illustrative embodiments, wherein:

FIG. 1 illustrates a half cell of a first embodiment of

FIG. 2 illustrates the half cell of FIG. 1 with a filter membrane at a next stage of construction;

FIG. 3 illustrates the half cell of FIGS. 1 and 2 with a mating half cell at a further stage of construction;

FIGS. 4A and 4B illustrate top and bottom oblique perspective views of the structure of FIG. 3 assembled with an overmolded binding to form a complete vessel;

FIG. 5 illustrates a mechanical mold form employed to simulate a proof of principle assembly of the vessel;

FIG. 6 illustrates a hinged construction for enhanced fabrication of individual cells;

FIG. 6A illustrates an asymmetric construction with a deadstopped retentate reservoir in accordance with the present invention.

### DETAILED DESCRIPTION

In general terms, the present invention addresses the need for an effective centrifugal ultrafiltration (UF) vessel by providing a vessel assembled from half-cells that are placed about a filter membrane and joined together, to form a complete closed cell or vessel. Each vessel has a port, and fluid passes from the interior, through the filter membrane to the port to concentrate or separate a retained component, such as a high molecular weight biomaterial, present in the starting fluid.

Applicant has previously, on Dec. 3, 1999, filed two patent application Ser. Nos. 09/454,032 and 09/454,391 (now issued as U.S. Pat. No. 6,269,957), disclosing various techniques and geometries for forming such clam shell ultrafiltration devices. Those applications, which include descriptions of relevant technological facts and discussions related to desirable vessel/filter geometry and shape, recovery efficiencies, properties of ultrafiltration membranes and the like, are hereby incorporated by reference in their entirety herein.

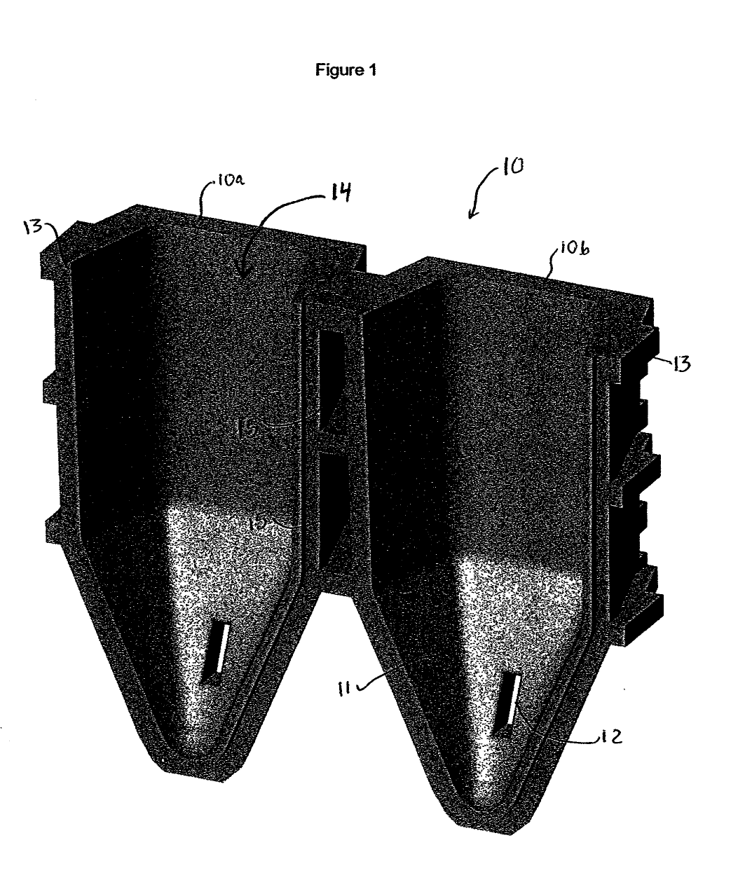

FIG. 1 shows one embodiment of a design for the half cells, i.e., a one-half clam shell. The invention may be carried out to form single vessels, strips of two or more vessels, or n by m arrays of vessels. That is, the array of vessels may be fabricated either as a single row of filter cells side by side or as an array of filter cells in rows and columns. For simplicity FIG. 1 shows an embodiment with only two wells. The design starts with such a half-cell member, to create the filter cells. The half-cell part 10 may be molded (e.g., blow molded or injection molded) from a plastic of high melting point (such as cellulose acetate) containing one or more half-reservoir cells, sectioned on the long axis, each cell having a top opening, a permeate port, and conical deadstop tip. The view of FIG. 1 is taken from a oblique perspective looking at the inside of the wells, showing a conical lower section 11with permeate port 12 as described in applicants' aforesaid U.S. Pat. No. 6,269,957. The half cells of this embodiment also include a raised sealing land 13 on a seal face bounding each half cell 10a, 10b. The top region of each half cell is contoured in a cell opening 14, forming the mouth into which sample is to be introduced in the completed vessels. The space between adjacent cells in the array embodiments has through-channels 15, as discussed further below, to allow the flow of plastic to wrap around and capture each cell during manufacture of the completed assembly.

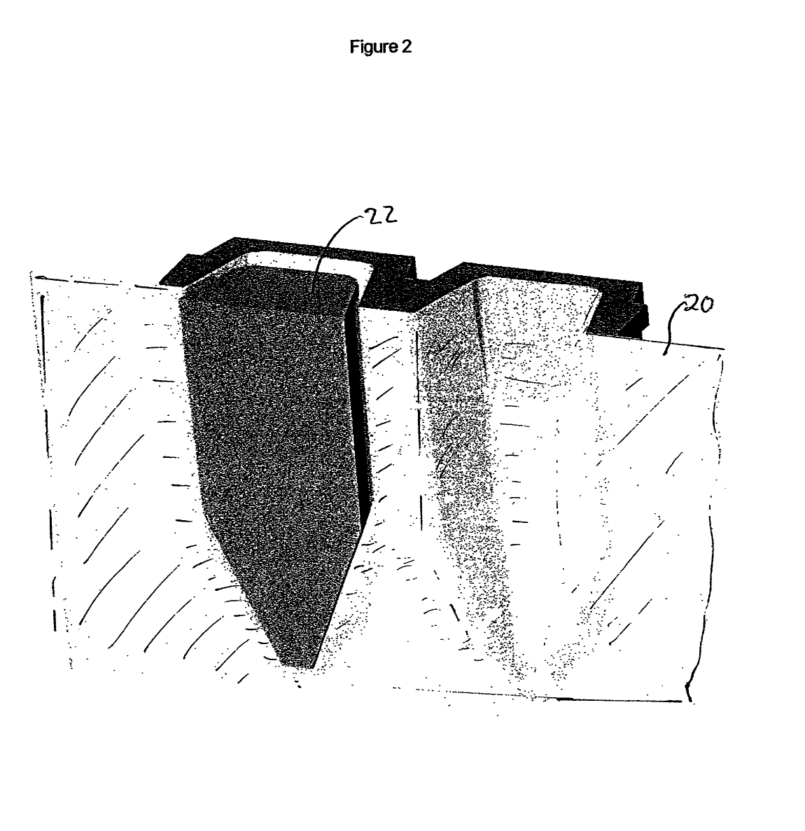

Over this series of half cells, a sheet 20 of filtration membrane is laid as shown in FIG. 2. This may be a membrane such as described in the aforesaid U.S. patent, and is preferably inserted with the skin side facing the interior, e.g., toward the viewer in FIG. 2. The membrane is forced into the cells with a forming “finger” 22 for each cell, of which one finger is shown for simplicity. In practice, for a strip of vessels, the fingers are formed as a strip of fingers, or a comb, having appropriate spacing and dimensions to mate with the array of cells. The sheet 20 may be cut or shaped to fit the cell or array of cells with minimal waste. Thus, in practice, the components for a manufacturing process reduce excess membrane area to use the membrane material more efficiently than shown in FIG. 2. The finger makes the membrane conform to the shape of the internal wall of the half cell 10a, 10b, covering the permeate ports 12 and the seal lands 13 or sealing regions around the perimeter. In the illustrated embodiment, the sheet 20 also covers the through channels 15.

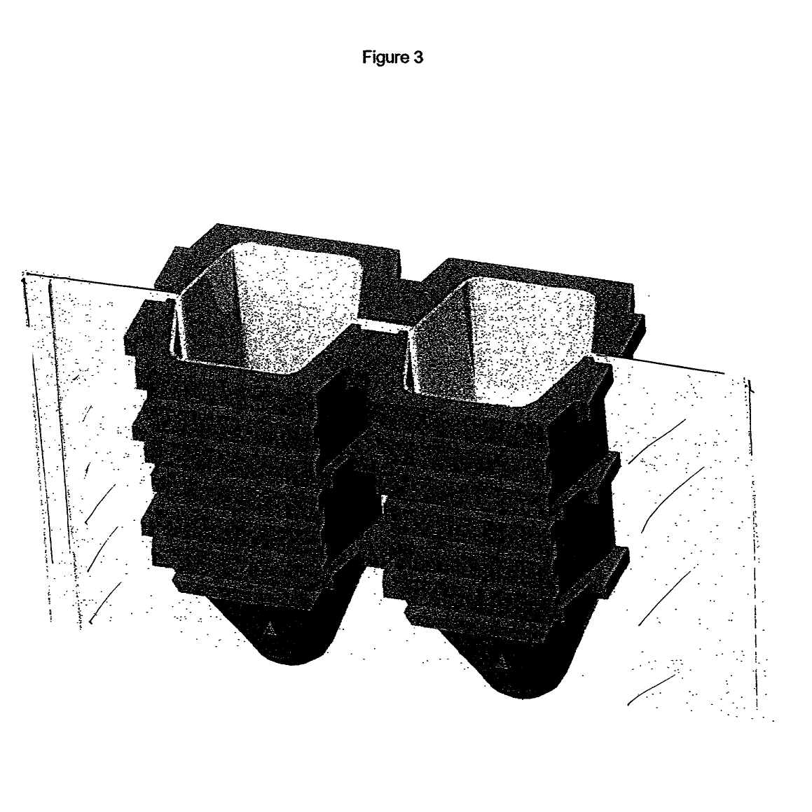

As illustrated in FIG. 3, a second sheet of filter materal 20′ is laid skin side down over this assembly 10, 20 of half cells, and a mating or mirror image strip of half cells 10′ is placed in alignment and pressed together with the assembly 10, 20. The shaped fingers preserve the sample reservoir volume, allowing use of large intact sheets of membrane while preventing the membranes from remaining flat during assembly. While the finger 22 is illustrated as having a planar central face, the fingers 22 may in practice be symmetric about the half plane (e.g., the joining plane of the two halves). Alternatively, the sheet 20′ may be urged against the wall of half cells 10′ by additional fingers similar to those illustrated in FIG. 2.

Once the two half-cell strips 10, 10′ are joined, they form a strip of full cells, as shown in FIG. 3. The illustrated cells have an upper hexagonal cylinder shape at their open end, and a conical or pyramidal bottom tip end. However, in other embodiments the entire cell body may be pyramidal or conical.

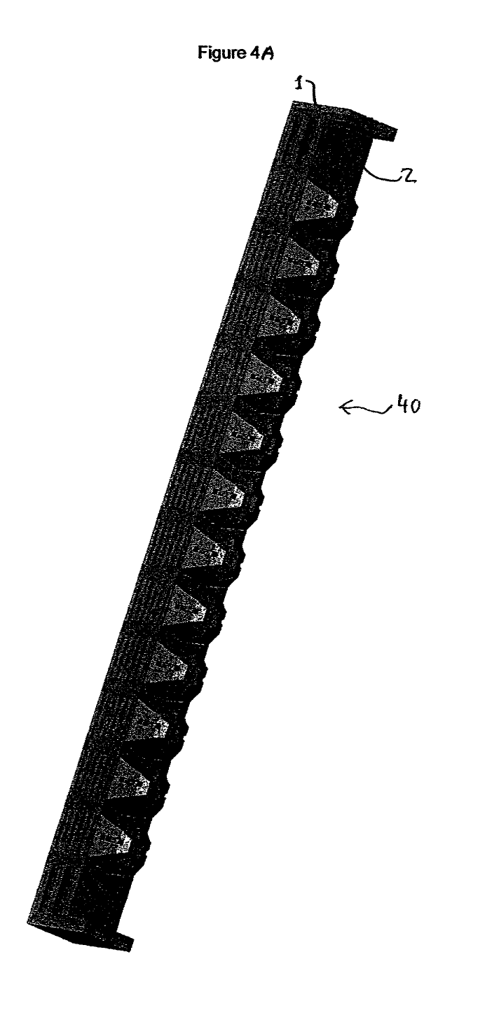

In accordance with a principal feature of this aspect of the invention, the aligned assembly of half cells and filter membranes is placed into an injection overmold and the two reservoir halves are compressed together within the mold with sufficient force that the membranes seal off skin against skin. This provides a unitary or seamless filter liner within the vessel constituted by each joined pair of half cells. A raised land around the edge of each reservoir cell serves to concentrate the press force facilitating the required crush, which may for example be about 7,000-8,000 psi around the edges of each cell, for the described polymer assembly. The crush force may be provided by mechanically urging opposed mold halves together (closing the mold), or may be provided by the injection pressure during overmolding. FIGS. 4A and 4B illustrate a completed overmolded strip 40 of twelve vessels so formed. The overmolded polymer 2 binds the vessels, and may also form an overall flange or body for mounting the array in a standard centrifuge drum or rack assembly.

The overmold, outside the crush regions, forms one or more surrounding cavities about the enclosed cells, and a plastic material of lower melting point than the material of cells 10,10′, for example a polyethylene or a polypropylene material is then injected into the injection overmold at a temperature/pressure effective to fill these cavities. The material thus forms a solid body around each filter cell and extending through openings 15 (FIG. 1).

The injected plastic material binds the vessel so formed, or the array of vessels, flowing through passages 15 between the cells, easily breaking through the excess membrane which spans these openings. Preferably the overmolded polymer forms a series of bands extending entirely around the individual cells of the two plastic half parts. The overmolded material may encase the lower conical region of each vessel, with appropriate channel or other shape to not occlude the outflow ports 12, FIG. 1, of the completed vessels. The overmolded bands function much like metal hoops on a barrel to provide what may be loosely termed radial busrt strength. As the enveloping plastic cools with the membrane sandwich still under compression, it shrinks, increasing the compressive force yet further. The mold is then opened, and the compressive load carried by the enveloping plastic bands helps to maintain effective membrane sealing. The outer plastic portion need not be limited to a band-type reinforcing or binding structure, but may include a generally enveloping structural body, or frame or web encasing or supporting the walls of the cells.

The step of overmolding as described above, and the step of providing a skin-to-skin compression seal between two membranes in assembling an ultrafiltration device each offer significant improvements in the construction of filter vessels, and in the operation of the vessels so constructed. The provision of a skin-to-skin seal permits 100% of the wetted area of the vessel interior to be formed from active membrane, giving maximal possible filtration area. This provides the maximal possible concentration rate and protein recovery. This amount of this increase may be appreciated from a consideration of the increase in cellulosic filter area of the constructions reported in the aforesaid United States patent (disclosing a somewhat similar cone geometry), which were discussed therein relative to typical prior art cellulosic ultrafiltration devices.

Another advantage of the present invention is that it allows the use of nearly any membrane with suitable tensile and elongation properties. This includes direct seals with regenerated cellulose, a material which is impossible to thermally bond by itself.

This is particularly advantageous since regenerated cellulose is often available only with a supporting substrate that itself retains adherent biomaterials, reducing the effective yields.

Another embodiment of the invention overcomes this problem, and achieves further benefits by using a regenerated cellulose membrane and a cellulose molded cell part with regenerated surfaces. This allows quantitative recovery of macromolecules, including those present in the filtrate, making it possible to perform fractionation and binding assays fairly directly with a centrifugal UF filter. Currently known devices are limited in their performance for these more challenging applications due to adsorptive loss of permeating species on hydrophobic plastic surfaces used to support the membrane. This further embodiment eliminates that source of loss.

The present invention also allows the rapid (more effective) assembly (manufacture) of a filter device without requiring the separate bonding of membrane to filter for each cell in the array. This ability to scale up and/or mechanize the manufacture of vessels with small and delicate filter elements is expected to dramatically reduce the cost of assembling a multiwell device and reduce sources of manufacturing defects.

Construction of filter vessels in this manner may be applied in a cost-effective manner to produce plates with a 96 (or more) well array of filtration cells, as well as the 12-well strip array of FIGS. 4A, 4B, with sample volumes at or below one milliliter. This format is very important for large scale screening and characterization of proteins. This same overall construction can be applied for larger devices as well, although other techniques already exist that are reasonably effective for many larger volume constructions. Those same techniques would not scale effectively to handle the smaller sample volumes.

The use of this skin-to-skin membrane seal, however, has broad application for the construction of separation devices of all sorts.

This overmolded assembly forming a finished product is shown in FIGS. 4A and 4B as a twelve-well strip unit. For clarity of illustration, the overmolded polymer appears darker in these figures, and the filter membrane is not shown. The illustrated assemblies are shown with an external profile that permits stacking of strips, so the basic units can then be built up as multiples of 12. Thus, for example, by stacking eight strips each having twelve cells, a 96 cell device can be made directly during a single “overmold” step using an overmold to contain the stack of components. In that case, the first and last pieces would be molded with half cells, and the intermediate parts would have opposing rows of half cells to form adjoining halves (back to back) of adjacent rows.

While not illustrated in the figures, the overmold may be configured so that the overmolded plastic forms a thin lip capturing the top of the membrane in each well to keep it neatly adjacent to the hexagonal walls of each cell. This can be accomplished by adding a chamfer to the top of each half cell to allow the overmolding plastic to flow only a short distance down into the wells until stopped by the forming finger (which advantageously remains contained in the assembly during the injection overmolding step).

Thus the present invention provides a method and structure for producforming multiple single well devices containing maximum membrane area with the benefit of economy of assembly cost through parallel (multicavity) overmold sealing of multiple device halves nested closely together in a fixture.

A further embodiment of the present invention, is a single vessel or a multiwell array of vessels that each employ a different second half part which forms a retentate cavity in its tip. That is, one cavity half-cell is not the mirror image of the other, but contains a small pocket, such as a protruding bulge, sized to hold the small amount of retentate, which as noted above may be a small percentage of the starting fluid volume.

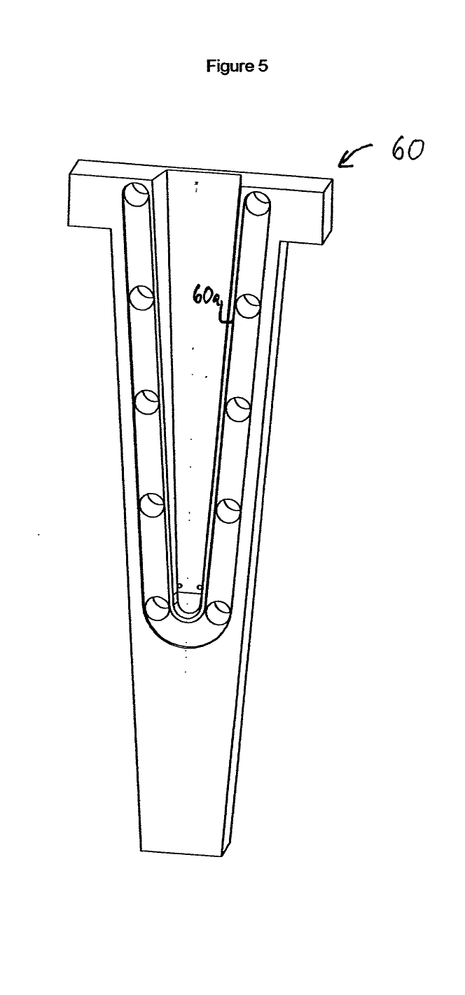

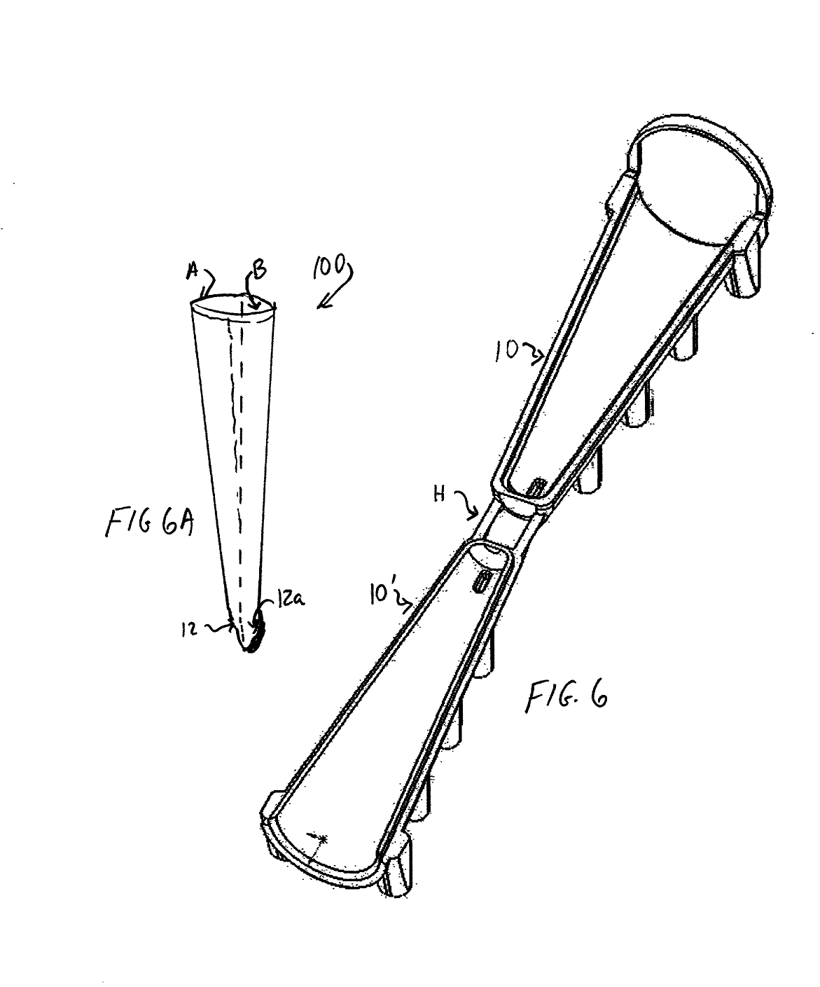

FIG. 6A is a perspective view of one such vessel 100, omitting the overmolded outer layer for clarity of illustration. In this embodiment, one cavity half cell, labeled the “A” part in the figure, contains the port or ports 12, while the other half, labeled the “B” half cell in FIG. 6A contains asmall-volume deadstopped retentate reservoir 12a. Only a single layer of filter membrane need be sealed between the mating halves, with its skin facing the B half containing the deadstop pocket. As before, the overmolding process provides the needed membrane sealing crush and assures vessel strength and integrity. Advantageously, with this construction asymmetric about the central plane, the concentrated (or concentrated and washed) retentate may be withdrawn by pipette from the pocket 12a without contacting or damaging the delicate UF membrane. This permits the vessel to be re-used multiple times, e.g., for successive washes, buffer exchange, concentration or other procedures.

FIG. 6 illustrates another embodiment, illustratively for forming an individual filter cell or vessel. As with the preceding embodiment, only the cells are shown. This construction has an integral hinge H that connects and aligns the two half cells, so that they may be simply folded over against each other. It thus forms a hinged clamshell cell structure. Assembly of the complete vessel proceeds analogously to that described for the array embodiments illustrated above. Moreover, the unitary clamshell hinge construction may also be applied to those strip embodiments.

Applicant has performed an engineering analysis and feasibility study of the membrane skin to membrane skin seal as described above, employing an aluminum clamping body to simulate the mold pressure conditions. EXAMPLE 1 below reports results of this study using cytochrome-c to evaluate sealing with a composite regenerated cellulose membrane cast on microporous polyethylene as sold by Millipore Corporation.

### EXAMPLE 1

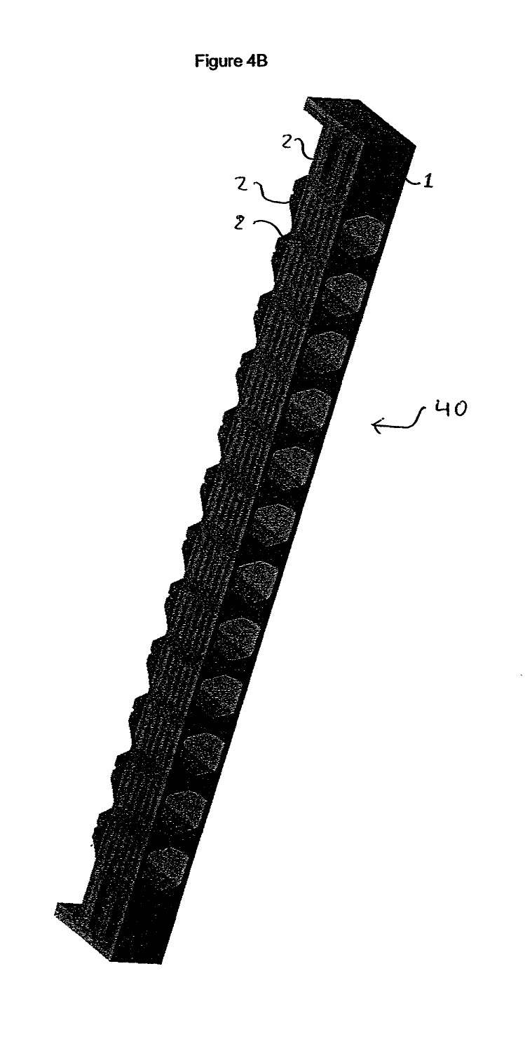

A skin-to-skin direct crush seal was formed in a size and shape corresponding to a single well maximal-area centrifugal concentrator using a pair of machined aluminum half clamping shells 60 as shown in FIG. 5 to simulate the half cells 10, 10′ (FIG. 1). The two halves were joined by multiple machine screws. The test cell shown can contain about 1 mL of sample and fits into a 50 mL conical tube, used in the simulation to collect the ultrafiltrate. During centrifugation, permeate passes through the two small holes, drilled in the corners about 0.1″ above the tip of each chamber half. These serve to form a hydrostatic deadstop of about 0.02 mL volume when used in a swing head rotor. A membrane-forming finger was made by casting urethane plug to fit the inside of the assembled device, each plug having a removal handle formed by a small screw that was inserted partly into the cavity from above before the casting resin cured. Three such cells were assembled with two pieces of 10,000 Dalton Quantitative Molecular Weight Limit composite regenerated cellulose membrane cast on microporous polyethylene (PLGCD), obtained from Millipore Corporation. The machine screws were tightened until snug, resulting in compression of the 0.007″ thick membrane to a final thithickness of 0.0034 to 0.0043″ along the 0.025″ wide sealing land (60a, FIG. 5) machined along the inner edge of each half.

Membrane seal integrity was challenged with 0.125 mg/mL Sigma C-2037 bovine heart cytochrome c dissolved in pH 7.4 0.01M phosphate buffered saline. Protein concentration was determined by optical density at 409 nm with a Gilford 260 spectrophotometer set to a slit width of 0.3 mm which was demonstrated to give linear response to the concentration of this protein to beyond 2.0 OD. One milliliter of sample was added to each cell and the three devices were centrifuged in a 34 degree fixed angle rotor at 4,000 rcf for twenty minutes. Filtrates were saved for OD reading, one milliliter of fresh buffer was added with pipette mixing to each device, and the devices spun again through four concentration cycles.

The results are shown in Table I.

TABLE I
Aluminum Clamshell Breadboard
10 kDa QMWL Diafiltration of Cytochrome c

| Device | | A1 | A2 | A3 |
|---|---|---|---|---|
| Crushed Thickness | | 0.0034″ | 0.0033″ | 0.0043″ |
| Cycle 1 | Challenge OD | 1.245 | 1.245 | 1.245 |
| | Filtrate OD | 0.019 | 0.012 | 0.016 |
| | Rejection | 98.5% | 99.0% | 98.7% |
| Cycle 2 | Challenge OD | 1.217 | 1.234 | 1.147 |
| | Filtrate OD | 0.018 | 0.01 | 0.01 |
| | Rejection | 98.5% | 99.2% | 99.1% |
| Cycle 3 | Challenge OD | 1.18 | 1.201 | 1.14 |
| | Filtrate OD | 0.01 | 0.009 | 0.011 |
| | Rejection | 99.2% | 99.3% | 99.0% |
| Cycle 4 | Challenge OD | 1.296 | 1.181 | 1.087 |
| | Filtrate OD | 0.006 | 0.005 | 0.387 |
| | Rejection | 99.5% | 99.6% | 64.4% |

All three devices demonstrated excellent retention of protein through three cycles of use. Device A3 developed a leak on the fourth spin, possibly reflecting the lesser degree of sealing crush with this device. These results demonstrate that a skin-to-skin crush seal of the invention quantitatively retains protein in a centrifugal concentrator vessel.

Vessel Surface Modifications

As noted above, material may be retained on adherent surfaces, reducing the yields of various ultrafiltration processes. There is thus a need for an improved molded cellulose acetate crush sealing part with superior ultrafiltrate recovery of unbound hydrophobic drugs and other ligands. This is addressed in one aspect of the invention by forming the vessel of cellulose acetate, and forming a regenerated surface on the vessel to prevent these components from being trapped by the vessel surface and removed from the ultrafiltrate.

Applicant has performed a further proof-of principle experiment to assess the effectiveness of such a vessel surface material by evaluating partial surface regeneration of a solid piece of extruded cellulose acetate rod. This requires regeneration of just the wetted surface to remove less polar acetyl moities while not deacetylating so deeply that the part become too rubbery to compress the ultrafiltration membranes 20, 20′ at sealing pressures. Results are reported in Example II, below.

### EXAMPLE II

Slices of extruded cellulose acetate 0.250 inch rod were cut into pieces of 0.05 inch length, having weights ranging between 50 and 52 milligrams. The pieces were treated with a 2% (by weight) sodium methoxide in methanol regenerant bath for varying times, and were rinsed and dried.

The degree of regeneration was tested by subjecting samples to acetone. The following Table 2 summarizes the results:

TABLE 2

| | | | Regenerated | |
|---|---|---|---|---|
| | Regeneration | | Length, Diameter | |
| Method | Time | | (in) | Effect of Acetone |
| Control | None | | 0.050, 0.250 | Immediately stuck to |
| | | | | beaker. Dissolved in 2 hr. |
| 1 | 5 | minutes | 0.050, 0.250 | Sample resisted sticking |
| | | | | to bottom of beaker for |
| | | | | approx. 5 minutes. |
| 2 | 10 | minutes | 0.050, 0.250 | Sample resisted sticking |
| | | | | for 25 minutes after which |
| | | | | the sample was rinsed and |
| | | | | dried. |
| 3 | 1.25 | hours | 0.089, 0.210 | No sticking. Rubbery |
| | | | | texture. Diameter shrinkage |
| | | | | and length growth |
| | | | | significant. |

The potential ability of the modified cellulose acetate disks to create a crush seal was then assessed by measuring its ability to compress 5,000 Dalton regenerated cellulose composite ultrafiltration membranes (Millipore PLCCC). Prior studies have shown need for sealing pressures in excess of 4,000 psi in order to provide an adequate crush seal of these membranes. The effectiveness of the compression seal so formed may be visually estimated by observing a change from opaque to transparent, as reported in Bowers and Yankopoulos, U.S. Pat. No. 5,733,449. A control and samples that had been regenerated by Method 1 and by Method 2 were each set-up into a fixture to apply increasing pressure to the edge of the disk pressing against the membrane surface.

The results were as follows:

| | | | Embossed | | | Radial |
|---|---|---|---|---|---|---|
| | | | Pattern | | | Crush |
| | P Gauge | Force | on Membrane | P Crush | Membrane | of CA |
| Method | (psi) | Ib) | (in) | (psi) | Appearance | Disk |
| Control | 3 | 13.4 | | | opaque | |
| Control | 5 | 22.4 | | | opaque | |
| Control | 8 | 35.8 | | | partial clear | |
| Control | 10 | 44.7 | 0.035 × 0.075 | 17028 | partial clear | .0025 in |
| 1 | 3 | 13.4 | | | opaque | |
| 1 | 5 | 22.4 | | | partial clear | |
| 1 | 8 | 35.8 | | | partial clear | |
| 1 | 10 | 44.7 | 0.035 × 0.110 | 11610 | partial clear | .006 in |
| 2 | 3 | 13.4 | | | partial clear | |
| 2 | 5 | 22.4 | | | partial clear | |
| 2 | 8 | 35.8 | 0.035 × 0.115 | 8894 | partial clear | 0.010 in |

Another 50 mg sample from Method 1 was subjected to acetone for 3 hours to extract the remaining cellulose acetate, then rinsed, dried, and found to weigh 2 mg. Based on an assumption that the 4% weight remaining is proportional to volume of regenerated cellulose, it is estimated that this sample was regenerated to a depth of 0.001 inch.

These results show that a surface shell can be formed on a cellulose acetate part that can protect the part from acetone without the surface thereby losing its ability to compress an UF membrane sufficiently to turn it transparent. This regenerated shell or surface layer should also reduce adsorption of hydrophobic solutes. Lesser levels of regeneration should suffice to reduce surface adsorption of solutes larger than acetone, while introducing even lower loss of the desired mechanical compression properties.

Thus, the ultrafiltration vessels described above in further embodiments are configured with inner vessel surfaces made no adherent or non retentive to form UF vessels for enhanced yield or quantitative filtrate separations.

Those having ordinary skill in the art will appreciate that various modifications can be made to the described illustrative embodiments and techniques without departing from the scope of the present invention. The invention being thus disclosed, variations and modifications thereof will occur to those having ordinary skill in the art, and such variations and modifications are considered to be within the scope of the invention, as defined by the claims appended hereto and equivalents thereof. All documents, publications and references cited above are hereby expressly incorporated herein by reference in their entirety.

What is claimed is:

1. A method of forming an ultrafiltration vessel, such method comprising the steps of arranging two sheets of filter material skin-to-skin between vessel halves and overmolding a compressive body around the vessel halves to form a vessel under conditions effective to seal the sheets against each other along edges thereof.

2. The method of claim 1, wherein the vessel halves are strips of multiple cells.

3. The method of claim 1, wherein the filter material is a regenerated cellulose material, and the vessel halves are a cellulose material having a regenerated surface.

4. The method of claim 2, wherein the strips are strips of n cells, where n is at least two cells, and the step of overmolding includes overmolding a stack of m strips to form an n by m array of ultrafiltration cells.

5. A method of forming an ultrafiltration vessel, such method comprising the step of arranging one sheet of filter material between a first vessel part having at least one port, and a second vessel part such that the filter material covers the at least one port, and overmolding a body around the first and second vessel parts to form a vessel under conditions effective to seal the sheet along edges thereof between the first and second vessel parts.

6. An ultrafiltration vessel, comprising
a vessel having an interior wall with an outlet port through the wall, and
an ultrafiltration membrane covering the outlet port,
wherein the interior wall has a regenerated cellulosic surface effective to minimize adsorption on said wall of material that passes through the filter to the port, thereby enhancing quantitative recovery of filtrate.

7. An ultrafiltration vessel, comprising
a vessel having an interior wall with an outlet port through the wall, and
an ultrafiltration membrane covering the outlet port,
the ultrafiltration membrane having a skin-to-skin seal effective to cover a full area of the vessel wall with said filter.

8. The ultrafiltration vessel of claim 7, wherein the vessel comprises first and second opposed half vessels, and the skin-to-skin seal is a crush seal effected between mating portions of the opposed half vessels.

9. The ultrafiltration vessel of claim 7, wherein the vessel comprises first and second opposed half vessels, and further comprising an overmolded body portion binding said half vessels together.

10. The ultrafiltration vessel of claim 7, wherein the vessel comprises symmetric first and second opposed half vessels.

11. The ultrafiltration vessel of claim 7, wherein the vessel comprises first and second opposed half vessels, the first half vessel including a port, and the second half vessel including a retentate reservoir positioned, in relation to the port, as a deadstop reservoir.

12. The ultrafiltration vessel of claim 12, wherein the deadstop reservoir is positioned for pipette access in a substantially conical vessel tip without contacting the ultrafiltration membrane thereby adapting the vessel for dependable reuse.
